(19) United States
(12) Patent Application Publication
(10) Pub. No.: US 2009/0176425 A1
(43) Pub. Date: Jul. 9, 2009

(54) FLEXIBLE KEYBOARD

(76) Inventors: Lung-Wen CHOU, Longjing Township (TW); Mei-Fang Chou, Longjing Township (TW); Hung-Tai Lin, Longjing Township (TW)

Correspondence Address: SINORICA, LLC, 2275 Research Blvd., Suite 500, ROCKVILLE, MD, 20850, US

(21) Appl. No.: 11/971,063

(22) Filed: Jan. 8, 2008

(51) Int. Cl. B32B 5/02

(52) U.S. Cl. 442/110

(57) ABSTRACT

A flexible keyboard includes a first layer combined with a second layer. The first layer has a first base cloth, a hot melt film spread on the first base cloth, and at least a first metallic sheet fixed on the hot melt film. The first metallic sheet is connected with a conducting line. The second layer has a second base cloth, a hot melt film spread on the second base cloth, and at least a second metallic sheet fixed on the hot melt film to correspond to the first metallic sheet. The second metallic sheet is connected with a conducting line. A foamed layer is sandwiched between the first layer and the second layer, with at least a gap formed for being pressed. So, if the invention is installed in clothes, a user can just press on the clothes corresponding to the gaps to operate an electronic appliance.

### BACKGROUND OF THE INVENTION

1. Field of the Invention

This invention relates to a keyboard, particularly to one installed in clothes to connect with an electronic appliance, so that a user can conveniently shift operating modes by pressing on the surface of the clothes.

2. Description of the Prior Art

Nowadays, the conventional radio has almost been replaced by an MP3 player, which is so small that it can be conveniently put in a pocket to let people enjoy music any time. However, as the MP3 player has a small size, it may easily slip off a hand while operating, possible to get damaged or to drop into a ditch unfortunately. Moreover, even though a user just wants to adjust volume, other function keys may be erroneously touched. Therefore, it is worthy of finding some ways to overcome the disadvantages mentioned above.

### SUMMARY OF THE INVENTION

The objective of this invention is to offer a flexible keyboard.

The main characteristics of the invention are a first layer, a second layer and a foamed layer. The first layer has a first base cloth, a hot melt film spread on the first base cloth, and at least a first metallic sheet fixed on the hot melt film. The first metallic sheet is connected with a conducting line. The second layer has a second base cloth, a hot melt film spread on the second base cloth, and at least a second metallic sheet fixed on the hot melt film to correspond to the first metallic sheet. The second metallic sheet is connected with a conducting line. A foamed layer is sandwiched between the first layer and the second layer, with at least a gap formed for being pressed. So, if the invention is installed in clothes, a user can conveniently press on the clothes corresponding to the gaps to operate an electronic appliance.

### BRIEF DESCRIPTION OF DRAWINGS

This invention is better understood by referring to the accompanying drawings, wherein:

FIG. 1 is a perspective view of a preferred embodiment of a flexible keyboard in the present invention;

FIG. 2 is a cross-sectional view of the preferred embodiment of a flexible keyboard in the present invention;

FIG. 3 is a cross-sectional view of the preferred embodiment of a flexible keyboard in the present invention, showing a gap being pressed; and

FIG. 4 is a sketching view of the preferred embodiment of a flexible keyboard in the present invention, showing it being installed in clothes to connect with an electronic appliance.

### DETAILED DESCRIPTION OF THE PREFERRED EMBODIMENT

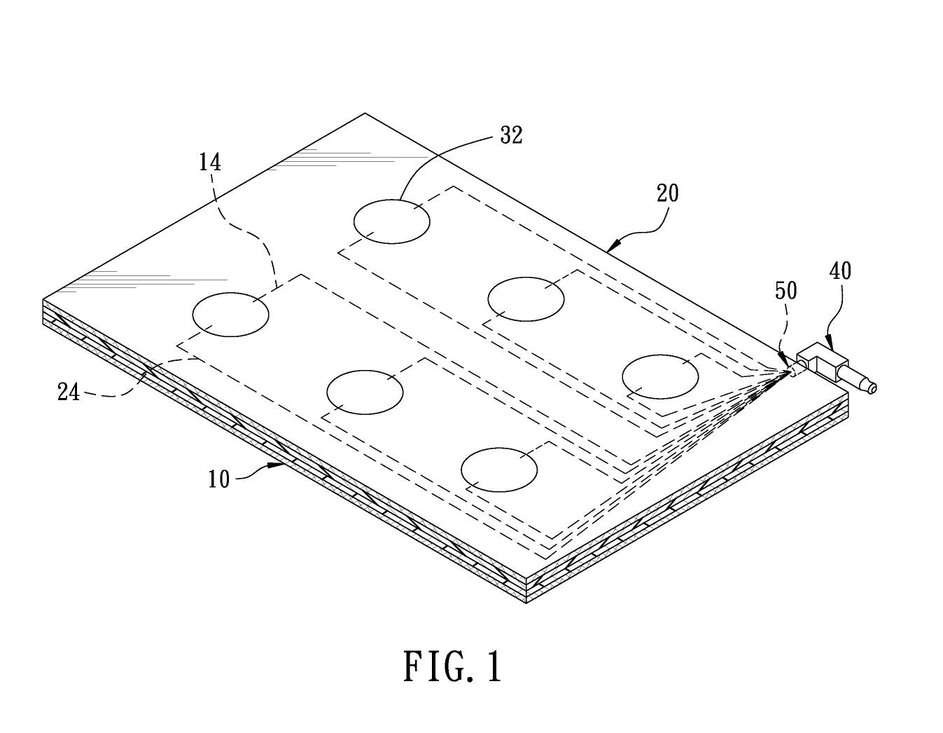

As shown in FIG. 1, a preferred embodiment of a flexible keyboard in the present invention is composed of a first layer 10, a second layer 20 and a foamed layer 30.

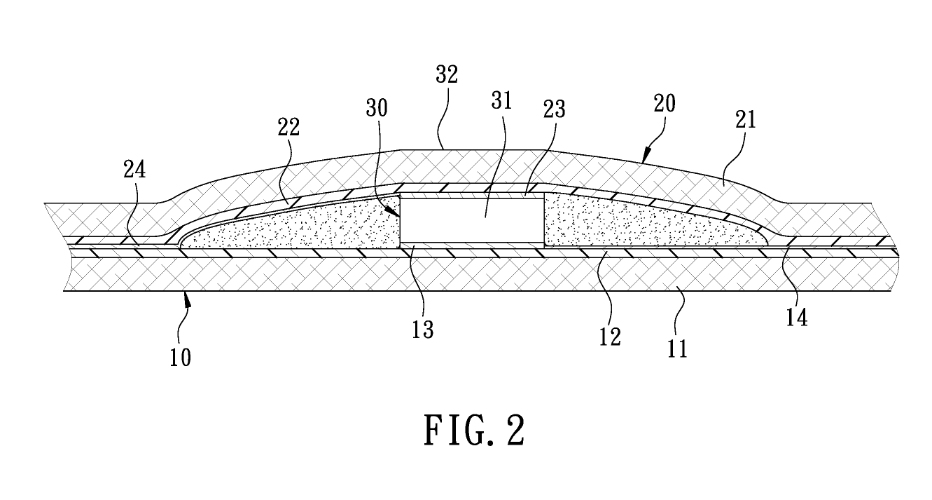

The first layer 10, with reference to FIG. 2, is provided with a first base cloth 11, a hot melt film 12 spread over the first base cloth 11, a metallic sheet 13 positioned on the hot melt film 12, and a conducting line 14 that is made of copper or carbon fiber, connected to one side of the first metallic sheet 13. The metallic line 14 in the embodiment is made of copper. And, the first base cloth 11 is made of cloth, non-woven fabric, superfine fiber or the like.

The second layer 20 is positioned on the first layer 10, provide with a second base cloth 21 having the locations corresponding to the first metallic sheet 13 printed with words of function keys, such as volume and exit etc. The second base cloth 21 is as well made of cloth, non-woven fabric, superfine fiber or the like. The bottom of the second base cloth 21 is coated with a hot melt film 22 that is also fixed with plural second metallic sheet 23 among its bottom, which are located to correspond to the first metallic sheet 13. And, a conducting line 24, made of copper or carbon, is connected to one side of the second metallic sheet respectively opposite to that connected with the conducting line 14. In the embodiment, the conducting line 24 is made of copper.

The foamed layer 30 is made of insulating material with a preset thickness, positioned between the first layer 10 and the second layer 20 to have a gap 31 formed exactly between the first metallic sheet 13 and the second metallic sheet 23 corresponding to each other with a proper distance for being pressed. Therefore, the top of the second layer 20 corresponding to each of the gaps 31 is formed slightly upward to be a bump 32. In addition, the first layer 10 and the second layer 20 are thermally welded together by high frequency process.

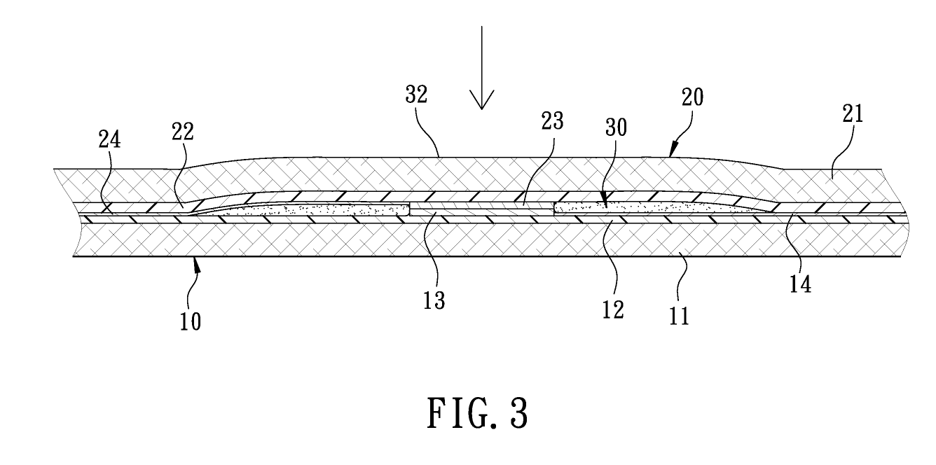

The free ends of the conducting lines 14 and 24 are collected together to be formed as a plug 40 positioned at a proper location to pass through a hole 50, which is appropriately formed at one side of the first layer 10 and the second layer 20 welded together. The plug 40 is used to connect with an electronic appliance. In using, as shown in FIG. 3, the bump 32 on the second layer 20 is pressed to enable the second metallic sheet 23 to touch the first metallic sheet 13 so as to command the electronic appliance to act as what is printed on the bump 32.

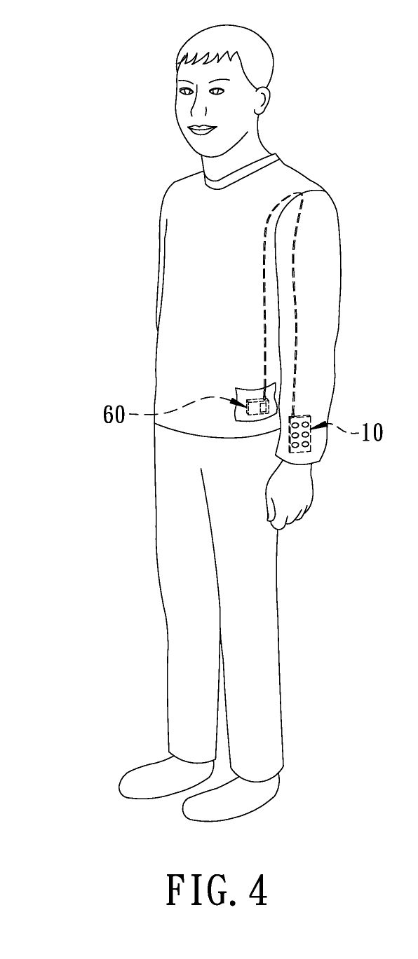

FIG. 4 shows that the present invention is installed in clothes. The first layer 10 and the second layer 20 are fixed inside a sleeve. The words of the function keys, such as volume and exit, corresponding to the bumps 32 are correspondingly printed on the outside of the sleeve. The plug 40 passing out through the hole 50 is provided with apertures (not shown in Figures) for connecting with an MP3 player 60 put in a pocket, so that a user can directly press the words of the function keys on the sleeve to operate the MP3 player 60. It is to be noted that the invention can be washed together with the clothes as the metallic sheets 13 and 23 and the conducting lines 14 and 24 are well protected by the hot melt films 12 and 22 to be waterproof.

In addition, with a speaker function key installed between the first layer 10 and the second layer 20 and with speakers directly installed in a collar, a user can press the speaker function key on the sleeve to directly listen music without wearing earphones.

The invention has the following advantages as can be seen from the foresaid description.

1. With the bumps 32 formed on the surface of the second layer 20 to correspond to the gaps formed among the foamed layer 30, and with the conducting lines 14 and 24 collected together to be easily connected with an electronic appliance, the invention can be installed in clothes to enable a user to conveniently shift operating modes on the surface of the clothes without touching the electronic appliance 60.

2. With the hot melt films 12 and 22 welded together by high frequency without usage of solvents, the present invention is not only unhurt to health, but also well confined to be waterproof so as to be permissibly washed with the clothes.

While the preferred embodiment of the invention has been described above, it will be recognized and understood that various modifications may be made therein and the appended claims are intended to cover all such modifications that may fall within the spirit and scope of the invention.

What is claimed is:

1. A flexible keyboard comprising:
a first layer provided with a first base cloth, a hot melt film spread over said first base cloth, at least a first metallic sheet installed on said hot melt film, a conducting line connected with said first metallic sheet;
a second layer fixed on said first layer and provided with a second base cloth, at least a second metallic sheet in stalled on said hot melt film to correspond to said first metallic sheet, a conducting line connected with said second metallic sheet; and,
a foamed layer made of insulating material with a preset thickness and installed between said first layer and said second layer with a gap formed exactly between said first metallic sheet and said second metallic sheet corresponding to each other.

2. The flexible keyboard as claimed in claim 1, wherein said first base cloth and said second base cloth are made of cloth, unwoven fabric, superfine fiber or the like.

3. The flexible keyboard as claimed in claim 1, wherein free ends of said conducting lines are collected together at a proper location to be formed as a plug to pass through a hole appropriately formed in one side of said first layer and said second layer welded together for connecting with an electronic appliance.

4. The flexible keyboard as claimed in claim 1, wherein said first layer and said second layer are welded together by high frequency process.

5. The flexible keyboard as claimed in claim 1, wherein said conducting lines of said first metallic sheet and those of said second metallic sheet are respectively connected in opposite sides.

6. The flexible keyboard as claimed in claim 1, wherein said conducting lines are made of carbon fiber.

7. The flexible keyboard as claimed in claim 1, wherein said conducting lines are made of copper.
